(19) United States
(12) Patent Application Publication
(10) Pub. No.: US 2012/0246158 A1
(43) Pub. Date: Sep. 27, 2012

(54) CO-RANGE PARTITION FOR QUERY PLAN OPTIMIZATION AND DATA-PARALLEL PROGRAMMING MODEL

(75) Inventors: Qifa Ke, Cupertino, CA (US); Yuan Yu, Cupertino, CA (US)

(73) Assignee: Microsoft Corporation, Redmond, WA (US)

(21) Appl. No.: 13/071,509

(22) Filed: Mar. 25, 2011

(51) Int. Cl. G06F 7/00; G06F 17/30

(52) U.S. Cl. 707/736; 707/E17.001

(57) ABSTRACT

A co-range partitioning scheme that divides multiple static or dynamically generated datasets into balanced partitions using a common set of automatically computed range keys. A co-range partition manager minimizes the number of data partitioning operations for a multi-source operator (e.g., join) by applying a co-range partition on a pair of its predecessor nodes as early as possible in the execution plan graph. Thus, the amount of data being transferred is reduced. By using automatic range and co-range partition for data partitioning tasks, a programming API is enabled that abstracts explicit data partitioning from users to provide a sequential programming model for data-parallel programming in a computer cluster.

### BACKGROUND

Data partitioning is an important aspect in large-scale distributed data parallel computing. A good data partitioning scheme divides datasets into multiple balanced partitions to avoid the problems of data and/or computation skews, leading to improvements in performance. For multi-source operators (e.g., join), existing systems require users to manually specify a number of partitions in a hash partitioner, or range keys in a range partitioner, in order to partition multiple input datasets into balanced and coherent partitions to achieve good data-parallelism. Such manual data partitioning requires users to have knowledge of both the input datasets and the available resources in the computer cluster, which is often difficult or even impossible when the datasets to be partitioned are generated by some intermediate stage during runtime.

Where automatic determination of the range keys is provided (e.g., in Dryad/DryadLINQ), it is limited to determination for single-source operators such as OrderBy. For an input I, an OrderBy operation is performed to sort the records in the input I. A down-sampling node down-samples the input data to compute a histogram of the keys of the down-sampled data. From the histogram, range keys are computed for partitioning the input data such that each partition in the output contains roughly the same amount of data. However, such an automatic determination cannot be made for multi-source operators (e.g., join, groupjoin, zip, set operators: union, intersect, except, etc.)

### SUMMARY

A co-range partitioning mechanism divides multiple static or dynamically generated datasets into balanced partitions using a common set of automatically computed range keys. The co-range partitioner minimizes the number of data partitioning operations for a multi-source operator (e.g., join) by applying a co-range partition on a pair of its predecessor nodes as early as possible in the execution plan graph. A programming API is provided that fully abstracts data partitioning from users, thus providing an abstract sequential programming model for data-parallel programming in a computer cluster. The partitioning mechanism automatically generates a single balanced partitioning scheme for the multiple input datasets of multi-source operators such as join, union, and intersect.

In accordance with some implementations, there is provided a data partitioning method for parallel computing. The method may include receiving an input dataset at a co-range partition manager executing on a processor of a computing device. The input dataset may be associated with a multi-source operator. A static execution plan graph (EPG) may be compiled at compile time. Range keys for partitioning the input data may be determined, and a workload associated with the input dataset may then be balanced to derive approximately equal work-load partitions to be processed by a distributed execution engine. The EPG may be rewritten in accordance with a number of partitions at runtime.

In accordance with some implementations, a data partitioning system for parallel computing is provided that includes a co-range partition manager executing on a processor of a computing device that receives an input dataset being associated with a multi-source operator. In the system, a high-level language support system may compile the input dataset to determine a static EPG at compile time. A distributed execution engine may rewrite the EPG at runtime in accordance with a number of partitions determined by the co-range partition manager. In the system, the co-range partition manager may balance a workload associated with the input dataset to derive approximately equal work-load partitions to be processed by a distributed execution engine.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 illustrates an exemplary data-parallel computing environment;

FIG. 2A illustrates histograms of two example datasets;

FIG. 2B illustrates an integration of the example datasets over the keys of FIG. 2A;

FIG. 3 is a diagram of example input, static, and dynamic execution plan graphs;

FIG. 4 is a diagram showing a rewrite of the dynamic execution plan graph by a co-range partition manager;

FIG. 5 is a diagram showing a rewrite of the dynamic execution plan graph by a CoSplitter;

FIG. 6 is a diagram showing a rewrite of the dynamic execution plan graph to minimize a number of partitions;

FIG. 7 is an operational flow of an implementation of a method of co-range partitioning; and

FIG. 8 is a block diagram of an example computing environment in which example embodiments and aspects may be implemented.

### DETAILED DESCRIPTION

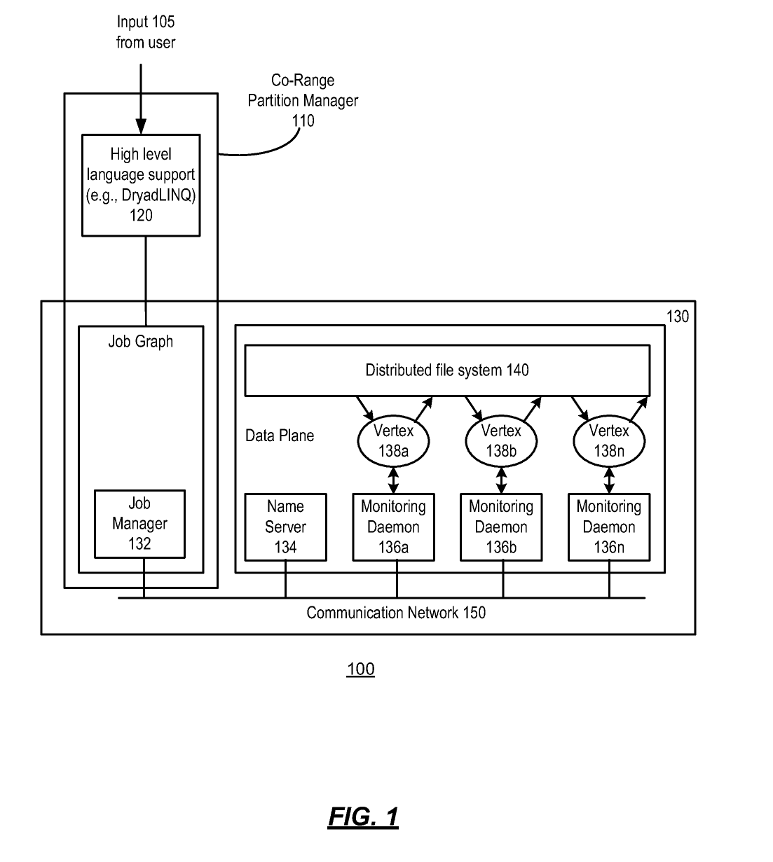

FIG. 1 illustrates an exemplary data-parallel computing environment 100 that comprises a co-range partition manager 110, a distributed execution engine 130 (e.g., MapReduce, Dryad, Hadoop, etc.) with high level language support 120 (e.g., Sawzall, Pig Latin, SCOPE, DryadLINQ, etc.), and a distributed file system 140. In an implementation, the distributed execution engine 130 may comprise Dryad and the high level language support 120 may comprise DryadLINQ.

The distributed execution engine 130 may include a job manager 132 that is responsible for spawning vertices (V) 138a, 138b . . . 138n on available computers with the help of remote-execution and monitoring daemons (PD) 136a, 136b . . . 136n. The vertices 138a, 138b . . . 138n exchange data through files, TCP pipes, or shared-memory channels as part of the distributed file system 140.

The execution of a job on the distributed execution engine 130 is orchestrated by the job manager 132, which may perform one or more of instantiating a job's dataflow graph; determining constraints and hints to guide scheduling so that vertices execute on computers that are close to their input data in network topology; providing fault-tolerance by re-executing failed or slow processes; monitoring the job and collecting statistics; and transforming the job graph dynamically according to user-supplied policies. The job manager 132 may contain its own internal scheduler that chooses which computer each of the vertices 138a, 138b . . . 138n should be executed on, or it may send its list of ready vertices 138a, 138b . . . 138n and their constraints to a centralized scheduler that optimizes placement across multiple jobs running concurrently.

A name server (NS) 134 may maintain cluster membership and may be used to discover all the available compute nodes. The name server 134 also exposes the location of each cluster machine within a network 150 so that scheduling decisions can take better account of locality. The daemons (D) 136a, 136b . . . 136n running on each cluster machine may be responsible for creating processes on behalf of the job manager. The first time a vertex (V) 138a, 138b . . . 138n is executed on a machine its code is sent from the job manager 132 to the respective daemon 136a, 136b . . . 136n, or copied from a nearby computer that is executing the same job, and it is cached for subsequent uses. Each of the daemons 136a, 136b . . . 136n acts as a proxy so that the job manager 132 can talk to the remote vertices 138a, 138b . . . 138n and monitor the state and progress of the computation.

In the high level language support 120, DryadLINQ may be used, which is a runtime and parallel compiler that translates a LINQ (.NET Language-Integrated Query) program into a Dryad job. Dryad is a distributed execution engine that manages the execution and handles issues such as scheduling, distribution, and fault tolerance. Although examples herein may refer to Dryad and DryadLINQ, any distributed execution engine with high level language support may be used.

The high level language support 120 for the distributed execution engine 130 may define a set of general purpose standard operators that allow traversal, filter, and projection operations, for example, to be expressed in a declarative and imperative way. In an implementation, a user may provide an input 105 consisting of datasets and multi-source operators.

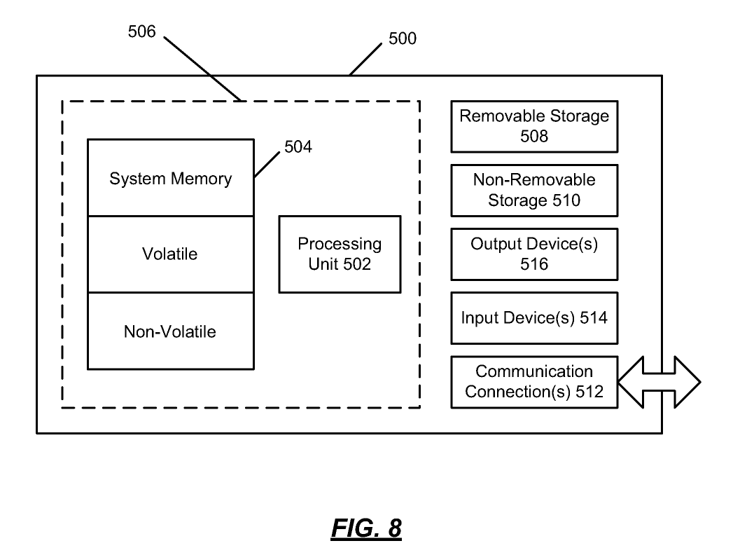

The co-range partition manager 110 fully abstracts the details of data partitioning from the users where the input 105 is a multi-source operator. In data-parallel implementations where the input 105 contains multi-source operators, the input 105 may be partitioned such that the records with the same key are placed into a same partition. As such, the partitions may be pair-wised and the operator applied on the paired partitions in parallel. This results in co-partitions for multiple inputs, i.e., there is one common partitioning scheme for all inputs that provides same-key-same-partition and balance among partitions. The co-range partition manager 110 may be implemented in one or more computing devices. An example computing device and its components are described in more detail with respect to FIG. 8.

The co-range partition manager 110 may divide multiple static or dynamically generated datasets into balanced partitions based on workload using a common set of automatically computed range keys, which in turn, are computed automatically by sampling the input datasets. Balancing of the workload associated with the input 105 is performed to account for factors, such as the amount of input data, the amount of output data, the network I/O, and the amount of computation. As such, the high level language support 120 may partition the input 105 by balancing workloads among machines using a workload function that may be derived from the inputs {Sᵢ, i=1, . . . , N}: Workload=ƒ(I₁, I₂, . . . ). Here Iᵢ is the key histogram of the i-th input S. The workload function may be determined automatically from a static and/or dynamic analysis of the code and data. Alternatively or additionally, a user may annotate the code or define the workload functions.

Workload depends on both the data and the computation on the data. A default workload function may be defined that is the sum of the number of records in each partition, such that the total number of records of corresponding partitions from all inputs is approximately the same ƒ(I₁, I₂, . . . , I_{N})=Σₖ₌₁^{N} size(Iₖ). To determine range keys for balanced partitions, approximate histograms are computed by sub-sampling input data. Uniform sub-sampling may be used to provide input data balance. For small keys, a complete histogram may be used.

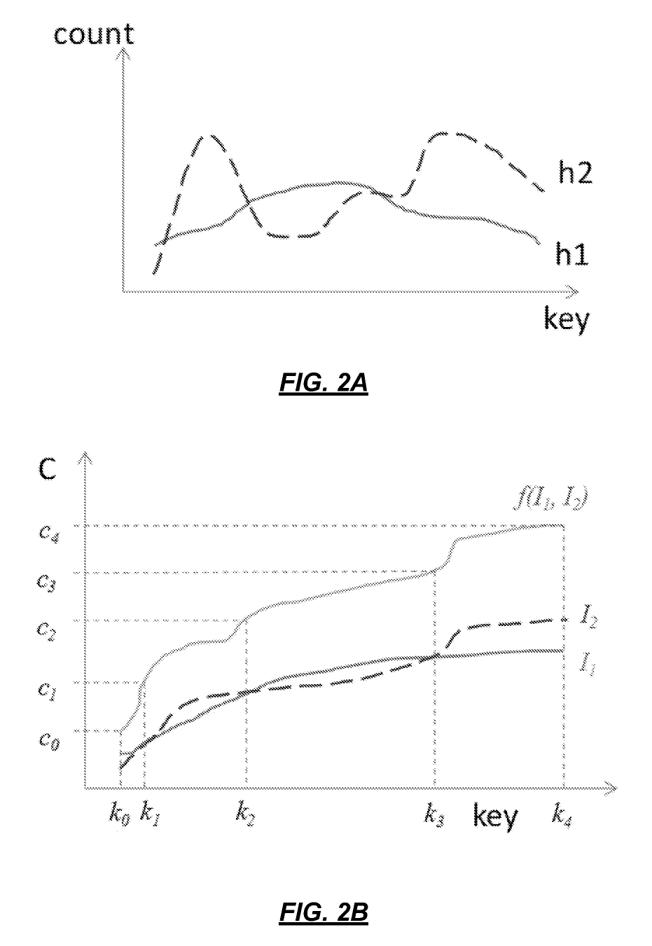

The range keys may be computed from the histograms, as described with reference to FIGS. 2A-2B. FIG. 2A illustrates histograms of two example datasets. FIG. 2B illustrates an integration of the example datasets over the keys of FIG. 2A. As shown in FIG. 2A, a common set of co-range keys for balanced partitioning is computed on two datasets. As shown, the histograms h₁ and h₂ are of two datasets, where k is the keys and C is the number of records with key=k. FIG. 2B shows, for each histogram, a cumulative distribution function (I₁ and I₂), which are an integration (over k) of h₁ and h₂, respectively. The f(I₁, I₂) is a composited function of I₁ and I₂. In the example shown, f(I₁, I₂)=I₁+I₂. To generate partitions for both datasets such that the sum of paired partitions are balanced, the range is divided to obtain the set {cᵢ} such that the intervals {Δi=cᵢ₊₁−cᵢ|i=0, 1, 2, 3} are equal to each other. Note that the y-axis value C is the number of records. The range keys may be obtained by projecting {cᵢ} onto the composited function f, and then projecting the intersection on the composited curve back to the k-axis. The keys {kᵢ|i=1, 2, 3, 4} are the resulting co-range keys that provide for balanced partitions.

In the example shown here, f(I₁, I₂)=I₁+I₂. Other functions may be used depending on the operator (that takes the two datasets as input). Other example composited functions are: f(I₁, I₂)=min (I₁, I₂), f(I₁, I₂)=max(I₁, I₂), f(I₁, I₂)=I₁*I₂. Alternatively or additionally, a composition of functions may be used as noted above. For example, for a join operator, it may be better to have balance on both I₁+I₂ and min(I₁, I₂). In this case, f(I₁, I₂)=I₁+I₂+min(I₁, I₂). The algorithm remains the same for generating the range keys for balance partitions for various f(I₁, I₂), and for more than two inputs.

Because multiple datasets are partitioned by common range keys, the partitioned results can be directly used by subsequent operators that take two or more source inputs, such as join, union, intersect, etc. The co-range partition manager 110 may be used statically for input data and/or it can be applied to an intermediate dataset generated by intermediate stages in a job execution plan graph (EPG). The EPG represents a “skeleton” of the distributed execution engine 130 data-flow graph to be executed, where each EPG node is expanded at runtime into a set of vertices running the same computation on different partitions of a dataset. The EPG may be dynamically modified at job running time. Thus, the co-range partition manager 110 may minimize the number of data partitioning operations, and thus the amount of data being transferred for a multi-source operator (e.g., join) by applying co-range partition on a pair of its predecessor nodes as early as possible in the execution plan graph.

In some implementations, the co-range partition manager 110 may expose a programming API that fully abstracts the data partitioning operation from the user, thus providing a sequential programming model for data-parallel programming in a computer cluster. For example, in the following code snippet:

int numPartitions = 1000;
var t1 = input1.HashPartition(x => x.key, numPartitions);
var t2 = input2.HashPartition(x => x.key, numPartitions);
var results = t1.Join( t2, x1 => x1.key, x2 => x2.key,
(x1, x2) => ResultSelector(x1, x2));

the API would eliminate the first three lines, which are conventionally defined by a user. As such, users may write their programs as if there is only one data partition.

Support for the features and aspects of the co-range partition manager 110 may be provided by one or both of the high level language support 120 and the distributed execution engine 130. For example, a high-level language compiler (e.g., DryadLINQ) may modify a static EPG to prepare primitives for the co-range data partition. A data/code analysis may be performed from sub-samples of the data and range keys. The job manager 132 (e.g., within Dryad) may support the co-range partition manager 110 by computing a number of partitions and may restructure or rewrite the EPG at runtime.

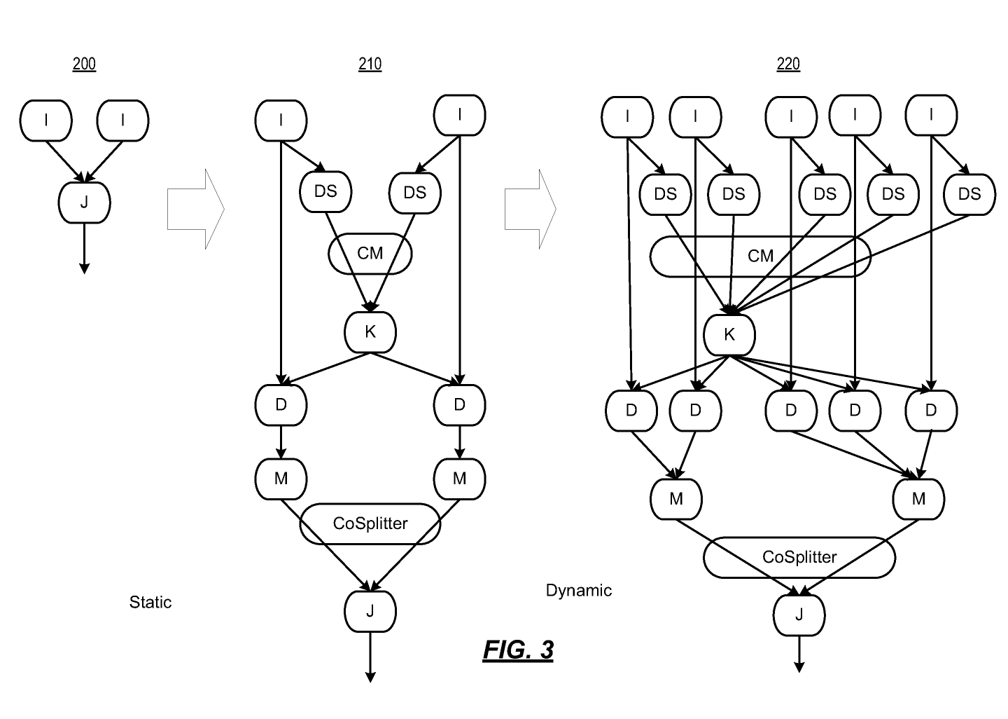

FIG. 3 illustrates example input, static and dynamic EPGs. An input graph 200 shows a join operator with two input tables. The input graph 200 may be received as the input 105, shown in FIG. 1. A static graph 210 is the execution plan generated at compile time by high level language support 120 (e.g., DryadLINQ). As shown, the two input datasets are co-range partitioned.

In the description of the graphs herein, down-sample nodes (DS) are nodes that down-sample the input data. A K node is a rendezvous point of multiple sources that introduces data dependency such that multiple down-stream stages depend on K node. This assures that the down-stream vertices are not run before rewriting of a dynamic graph 220 is completed. The K node may compute range keys from histograms of sampled data and saves the range keys if the co-partitioned tables are materialized, as described below. In some implementations, the node K may perform a second down-sampling if the first down-sampled data provided by the DS node is large. The second down-sampling may be performed using a sampling rate r, as follows:

r=(maximum allowable input size for K)/(size of DS data).

A co-range partition manager (CM) node is in the job manager 132 (e.g., in Dryad) and performs the aforementioned rewriting of the dynamic graph 220. A range distributer (D) node distributes the data based on the range keys determined by the K node. A CoSplitter node sits on top of join nodes (J) and merge nodes (M) in the graph. The CoSplitter coordinates splitting of the join nodes (J) and merge nodes (M), as described below.

The graph 220 illustrates an initial graph created at runtime before the graph is rewritten by the co-range partition manager 110. To determine a rewritten graph, the co-range partition manager (CM), which resides between DS nodes and K node, may determine a number of partitions using down-sampled data provided by the DS nodes, as follows:

N=(size of subsampled data/sampling rate)/(size per partition).

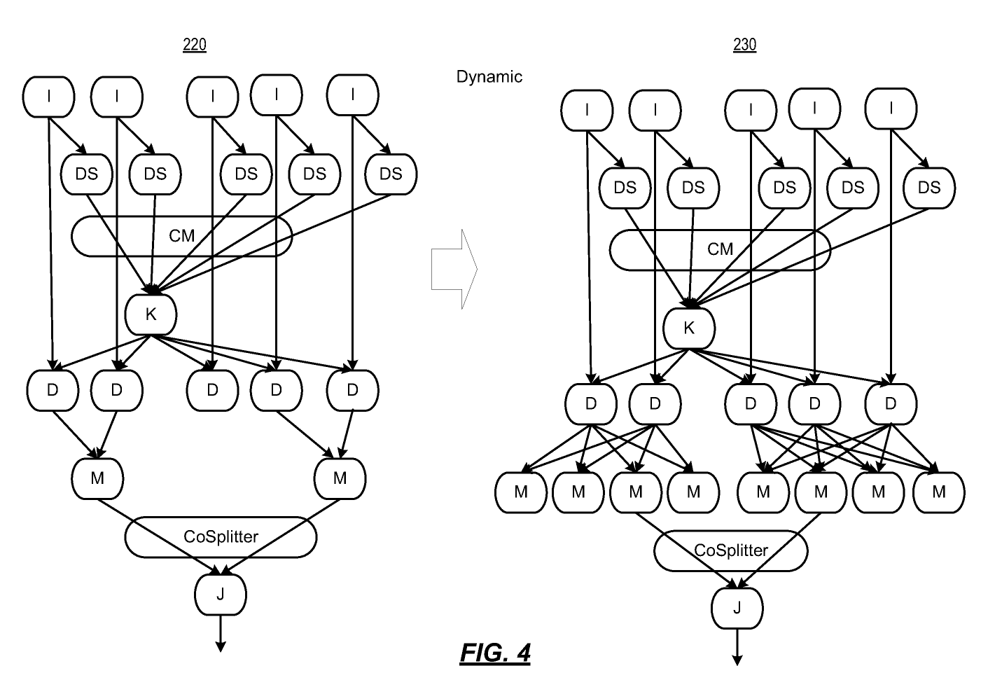

With reference to FIG. 4, there is shown a diagram of a rewrite applied to the dynamic execution plan graph 220 of FIG. 3. Based on the determined value of N, the co-range partition manager (CM) may rewrite the down-stream graph developed by the K node (i.e., graph 220) in accordance with N (e.g., 4), by splitting the M nodes into N copies into a graph 230. The graph 230 shows the M node split into four copies by the co-range partition manager (CM).

In accordance with some implementations, sampling overhead may be reduced. To accomplish the reduction, the co-range partition manager (CM) may compute a partition count using a size of original data, as follows:

N=(size of input data)/(size of partition).

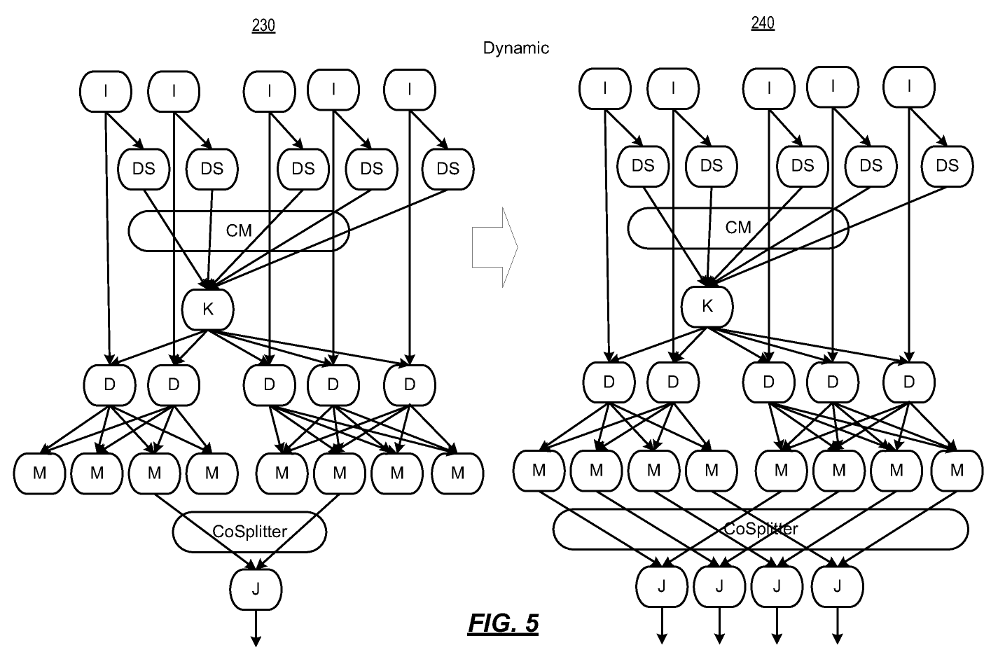

As shown in FIG. 5, there is illustrated a rewrite of the graph 230 by the CoSplitter. The CoSplitter may rewrite the graph 230 to split the J node into multiple copies based on the determined value of N (e.g., 4). The graph 240 shows the J node split into four copies by the CoSplitter.

Additionally or alternatively, overhead may be reduced within the DS node by keeping only the keys, rather than a whole record. The can be done because the CM node computes the number of partitions from the size of the input data, rather than size of the down-sampled data. In particular, the keys are typically much smaller than whole record, which provides for the lower overhead and a higher sampling rate. A higher sampling rate provides for a more accurate estimation of the range keys.

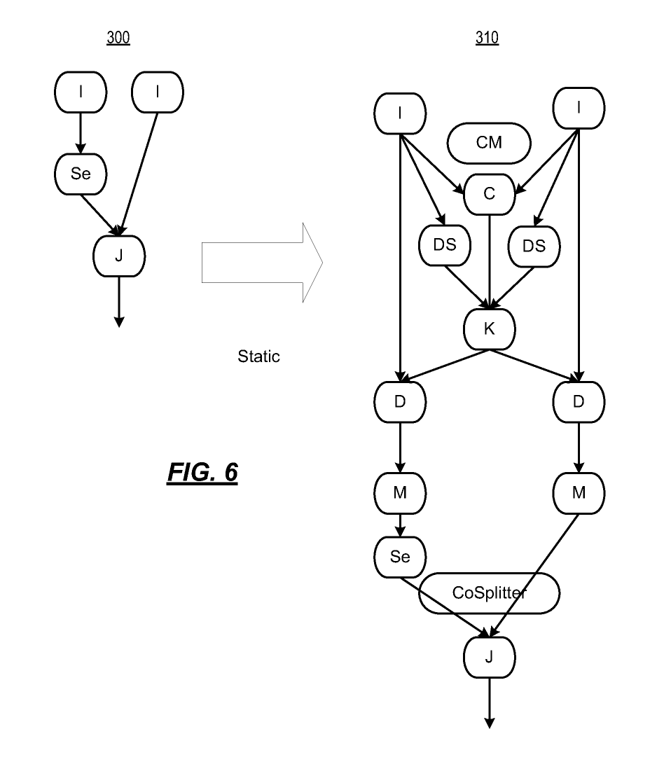

In some implementations, execution plan optimization may be performed to minimize the total data partitioning operations. FIG. 6 is a diagram showing a rewrite of the dynamic execution plan graph to minimize a number of partitions for two inputs that represent the following relationship:

```
var t1 = input1.Select( x => f(x) );
var results = input2.Join(
                t1,
                x1 => x1.key,
                y1 => y1.key );
```

One input I goes through a select operation (Se), and a join operation (J) is applied to the output of the Se operation and a second input I. In this example, the co-range partition manager 110 may identify that co-partitioning of the two inputs is to be performed. However, the number of partitions associated with the input I to the Se is relatively small. Each partition, thus, is very large, so repartitioning of the data may be beneficial to provide better parallelism. Also, the join operation (J) needs to co-partition its two inputs. As such, the original plan has two data partitioning operations.

In accordance with some implementations, the above can be reduced to one partitioning by pushing the partitioning operation upstream from J node as far as possible while maintaining same-key-same-partition invariance. In so doing, the new execution plan 310 needs only one partitioning operation, as shown on the right of FIG. 6.

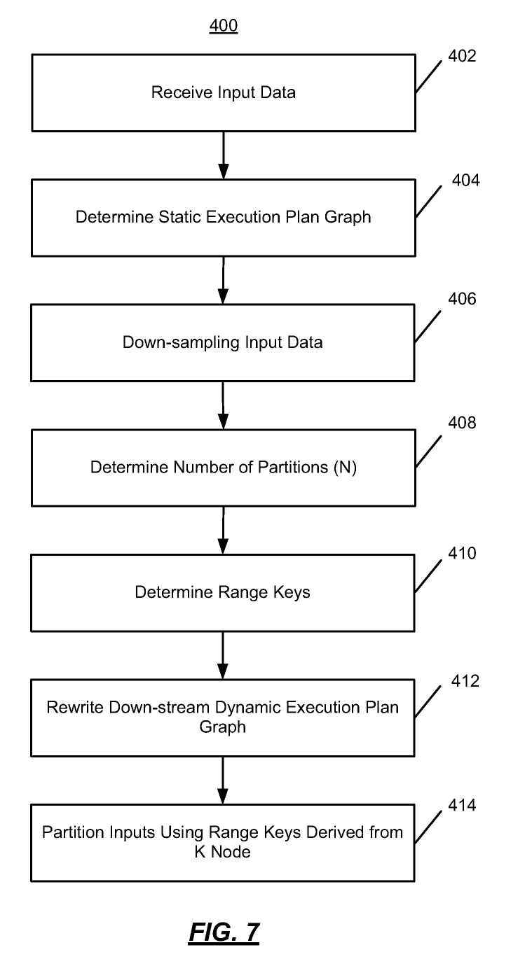

FIG. 7 is an operational flow of an implementation of a method 400 of co-range partitioning. At 402, input data is received. Input data and/or datasets may be received by the co-range partition manager 110. The input 105 may be associated with a multi-source operator and provided to the co-partitioning framework through an exposed programming API.

At 404, the static EPG is determined. The static EPG may be determined at compile time by the high level language support 120 (e.g., DryadLINQ). At 406, the input data is down-sampled by DS node to create a representative dataset for later stages to determine the number of partitions and the range keys.

At 408, a number of partitions is determined. For example, the co-range partition manager (CM) node may compute a number of partitions (N) using down-sampled data provided by the DS node.

At 410, the range keys are determined. The histograms of the down-sampled data may be developed. As part of a runtime analysis, the co-partitioning framework may automatically derive the workload function such that the size of each partition is approximately the same. The K node may compute the range keys from the histograms such that each partition contains roughly the same amount of workload. The co-range partition manager 110 may automatically handle keys that are equitable, but not comparable. This is a situation where two keys are equal, but the order of the keys cannot be determined. A hash code may be determined for each of the keys, where the hash code is, e.g., an integer value, a string value, or any other value that can be compared. A class may be provided that tests the integer value for each key to derive a function expression that makes the keys comparable. For example, the following may be used to compare the integer values:

```
public class ComparerForEquatable<T> : IComparer<T>
{
      private IEqualityComparer<T> m_ep;
      ...
      public int Compare(T x, T y)
      {
        int hx = m_ep.GetHashCode(x);
        int hy = m_ep.GetHashCode(y);
        return hx.CompareTo(hy);
      }
}
```

The above maintains same-key-same-partition invariance such that the same keys go into the same partition, as the same keys will result in the same integer value in the comparator. As such, the above converts equitable keys to comparable keys.

At 412, the down-stream graph may be rewritten. For example, the co-range partition manager (CM) may rewrite the EPG by splitting the M nodes into N copies, and the CoSplitter may split J node into N copies accordingly. A dynamic execution plan graph rewrite process may be performed to reduce overhead. The co-range partition manager CM may determine a partition count using the size of original data. From that, the CM may rewrite the down-stream graph to split the M node based on the determined value of N. In some implementations, at 414, the K node may perform a second down-sampling if the first down-sampled data is large. The second down-sampling may be performed using a sampling rate r, as described above to rewrite the dynamic plan graph.

Thus, as described above, there is a method for automatically partitioning datasets into multiple balanced partitions for multi-source operators.

FIG. 8 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 8, an exemplary system for implementing aspects described herein includes a computing device, such as computing device 500. Computing device 500 depicts the components of a basic computer system providing the execution platform for certain software-based functionality in accordance with various embodiments. Computing device 500 can be an environment upon which a client side library, cluster wide service, and/or distributed execution engine (or their components) from various embodiments is instantiated. Computing device 500 can include, for example, a desktop computer system, laptop computer system or server computer system. Similarly, computing device 500 can be implemented as a handheld device (e.g., cellphone, etc.). Computing device 500 typically includes at least some form of computer readable media. Computer readable media can be a number of different types of available media that can be accessed by computing device 500 and can include, but is not limited to, computer storage media.

In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 8 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 8 by removable storage 508 and non-removable storage 510.

Computing device 500 typically includes a variety of computer readable media. Computer readable media can be any available media that can be accessed by device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communications connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A data partitioning method for parallel computing, comprising:
receiving an input dataset at a co-range partition manager executing on a processor of a computing device, the input dataset being associated with a multi-source operator;
determining a static execution plan graph (EPG) at compile time;
balancing a workload associated with the input dataset to derive a plurality of approximately equal work-load partitions to be processed by a distributed execution engine;
determining a plurality of range keys for the partitions; and
rewriting the EPG in accordance with a number of partitions (N) at runtime.

2. The method of claim 1, further comprising:
exposing a programming API by the co-range partition manager; and
receiving a call to the programming API with the input dataset, such that a partitioning process is abstracted from a user.

3. The method of claim 1, wherein determining the range keys further comprises:
down-sampling the input dataset to create down-sampled data;
developing histograms of the down-sampled data; and
determining the range keys from the histograms.

4. The method of claim 3, further comprising:
determining a hash code for each of the keys if the keys are not comparable; and
ordering each of the range keys in accordance with the hash code for each of the range keys.

5. The method of claim 4, wherein the hash code is one of an integer value and a string value.

6. The method of claim 4, further comprising placing records with keys having a same hash code in a same partition to maintain same-key-same-partition invariance.

7. The method of claim 1, wherein rewriting the EPG in accordance with the number of partitions at runtime further comprises:
determining the number of partitions (N) using down-sampled data; and
splitting an M node associated with the EPG into N copies by a co-range partition manager associated with the M node.

8. The method of claim 7, further comprising determining the number of partitions (N) in accordance with relationship N=(size of subsampled data/sampling rate)/(size per partition).

9. The method of claim 7, further comprising splitting a J node associated with the EPG into N copies by a co-range partition manager associated with a M node and a J node.

10. The method of claim 9, further comprising determining the number of partitions (N) in accordance with N=(size of input data)/(size of partition).

11. A data partitioning system for parallel computing, comprising:
a co-range partition manager executing on a processor of a computing device that receives an input dataset being associated with a multi-source operator;
a high-level language support system that compiles the input dataset to determine a static execution plan graph (EPG) at compile time; and
a distributed execution engine that rewrites the EPG at runtime in accordance with a number of partitions (N) determined by the co-range partition manager,
wherein the co-range partition manager balances a workload associated with the input dataset to derive a plurality of approximately equal workload partitions to be processed by a distributed execution engine.

12. The system of claim 11, wherein the co-range partition manager exposes a programming API to receive the input dataset.

13. The system of claim 11, wherein the co-range partition manager determines a plurality of range keys by down-sampling the input dataset to create down-sampled data, developing a plurality of histograms of the down-sampled data, and determining the range keys from the histograms.

14. The system of claim 13, wherein the co-range partition manager determines a hash code for each key, and compares the keys in accordance with the hash code for each of the keys.

15. The system of claim 14, wherein range keys having a same hash code are placed in a same partition to maintain same-key-same-partition invariance.

16. The system of claim 11, wherein a number of partitions (N) is determined using down-sampled data provided by a DS node of the EPG, and wherein an M node associated with the EPG is split into N copies by a co-range partition manager associated with a K node.

17. The system of claim 16, wherein a J node associated with the EPG is split into N copies by a co-range partition manager associated with a J node and a M node.

18. A data partitioning method for parallel computing, comprising:
determining a static execution plan graph (EPG) at compile time from an input dataset associated with a multi-source operator;
balancing a workload associated with the input dataset to derive a plurality of approximately equal work-load partitions to be processed by a distributed execution engine; and
rewriting the EPG in accordance with a number of partitions (N) at runtime.

19. The method of claim 18, further comprising:
determining a plurality of range keys from a plurality of histograms of down-sampled input datasets; and
comparing the range keys to determine an order of the range keys.

20. The method of claim 18, further comprising splitting an M node associated with the EPG into N copies by a co-range partition manager associated with the M node; and
splitting a J node associated with the EPG into N copies by a co-range partition manager associated with a M node and a J node.
